(19) United States
(12) Patent Application Publication
(10) Pub. No.: US 2016/0126805 A1
(43) Pub. Date: May 5, 2016

(54) SYSTEM AND METHOD FOR POWER GENERATION

(71) Applicant: General Electric Company, Schenectady, NY (US)

(72) Inventors: Alexander Felix Fiseni, Munchen (DE); Francesco Papini, Munchen (DE)

(21) Appl. No.: 14/533,252

(22) Filed: Nov. 5, 2014

(51) Int. Cl. H02K 7/18

(52) U.S. Cl. CPC H02K 7/1846

(57) ABSTRACT

A power generation system includes a conducting tube and a generating unit configured to move linearly over a conductive surface of the conducting tube. Further, the generating unit includes a magnetic rotor configured to create a first magnetic field proximate the conductive surface and a stator disposed concentric with and radially inside the magnetic rotor, and including electrical coils. The magnetic rotor rotates about the stator to induce a voltage in the electrical coils when the generating unit moves linearly over the conductive surface of the conducting tube.

### BACKGROUND

The disclosure relates generally to an inspection system and more specifically to power generation in a device used for pipeline inspection.

Typically, in oil and gas distribution sector, underground pipelines are used to transport fuels including crude hydrocarbon to one or more locations. However, these pipelines may be subjected to leaking, wall thickness, deformation, and/or corrosion related damages due to ageing of the pipelines.

To prevent these damages, pipeline owners and/or operators routinely inspect pipelines from the inside. Particularly, an inspection device is sent through the pipelines to check any damages in the pipelines. The inspection device collects data from inside the pipelines, for example, data indicating wall thickness, deformation to the pipeline, and/or other corrosion related damages in the pipelines. Further, this data is retrieved and analyzed to identify damages in the pipelines.

However, during inspection of the pipelines, the inspection device may have to travel hundreds of kilometers inside the pipelines without the possibility to recharge on-board batteries that are supplying the device electronics. Moreover, to detect the state of welding inside the pipelines, the inspection device may be equipped with an X-Ray generator and/or other sensor that consumes more power from the on-board batteries. This results in rapid depletion of the on-board batteries and may deactivate the inspection device.

Thus, the inventors have provided an improved system and method for power generation.

### BRIEF DESCRIPTION

In accordance with one embodiment described herein, a power generation system includes a conducting tube and a generating unit configured to move linearly over a conductive surface of the conducting tube. Further, the generating unit includes a magnetic rotor configured to create a first magnetic field proximate the conductive surface and a stator disposed concentric with and radially inside the magnetic rotor, and including electrical coils. The magnetic rotor rotates about the stator to induce a voltage in the electrical coils when the generating unit moves linearly over the conductive surface of the conducting tube.

In accordance with a further aspect of the present disclosure, a method for generating electrical power includes disposing a magnetic rotor proximate to a conductive surface of a conducting tube, wherein the magnetic rotor creates a first magnetic field proximate the conductive surface. Further, the method includes varying the first magnetic field by a linear movement of a generating unit over the conductive surface. Also, the method includes converting the linear movement of the generating unit into rotational movement of the magnetic rotor when the first magnetic field is varied. Furthermore, the method includes inducing a voltage in electrical coils of a stator from the rotational movement of the magnetic rotor.

In accordance with another aspect of the present disclosure, a power generating device includes a generating unit configured to move linearly over a conductive surface. The generating unit includes a stator comprising electrical coils, and a magnetic rotor disposed concentric with and radially outside the stator. The magnetic rotor is configured to create a first magnetic field proximate the conductive surface, and rotate about the stator to induce a voltage in the electrical coils when the generating unit moves linearly over the conductive surface.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a power generation system, in accordance with one embodiment of the present disclosure;

FIG. 2 is an isometric view of the power generation system, in accordance with one embodiment of the present disclosure;

FIG. 3 is a diagrammatical representation of a magnetic rotor in the power generation system, in accordance with one embodiment of the present disclosure;

FIG. 4 is a schematic diagram of electrical coils in a stator coupled to an external unit, in accordance with one embodiment of the present disclosure; and

FIG. 5 is a flow chart illustrating a method for generating power in an inspection device, in accordance with one embodiment of the present disclosure.

### DETAILED DESCRIPTION

As will be described in detail hereinafter, various embodiments of an exemplary power generation system are presented. By employing the methods and the various embodiments of the power generation system described hereinafter, one or more on-board batteries in an inspection device may be efficiently recharged while the inspection device is travelling through pipelines.

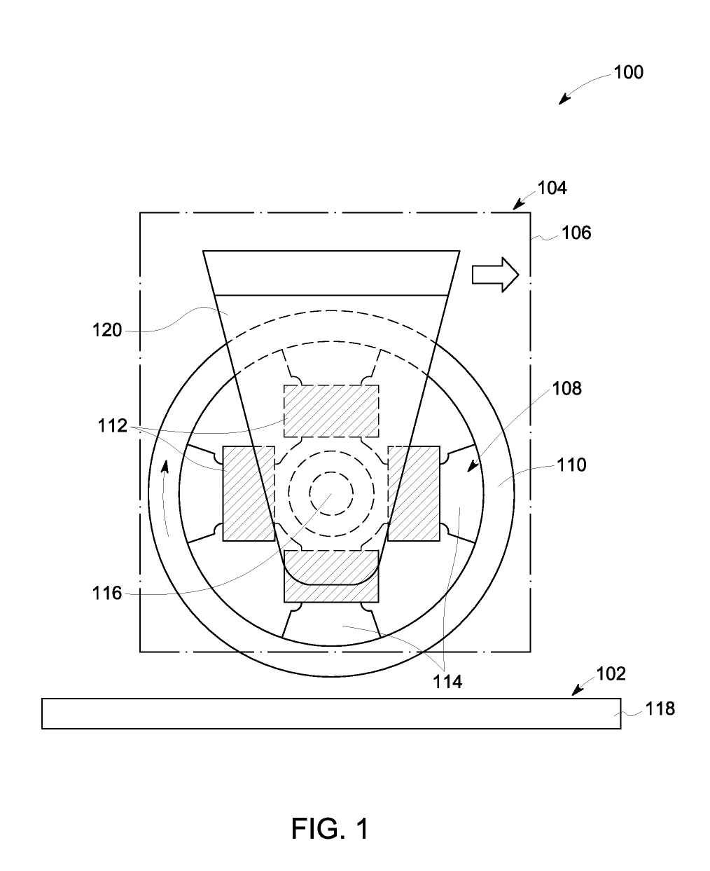

Referring to FIG. 1, a diagrammatical representation of a power generation system 100, in accordance with one embodiment of the present disclosure, is depicted. In one embodiment, the power generation system 100 generally includes an inspection device 104 configured to move linearly over a conductive surface 118. The conductive surface 118 may be any conductive surface suitable to facilitate operation of the power generation system 100 as described herein. For example, in one embodiment, the conductive surface 118 may be a conducting tube 102. In such an embodiment, the conducting tube 102 may be a portion of the pipeline that is used for transporting fuels from one location to another location. In one example, the conducting tube 102 may be magnetic or non-magnetic tube but electrically conducting, such as aluminum, copper, steel, stainless steel, magnesium, and/or conductive plastic tube.

Further, the inspection device 104 may be sent through the pipeline to check any damages in the pipeline. In one example, the inspection device 104 may travel hundreds of kilometers through the pipeline located in remote and urban areas. Also, the inspection device 104 may collect data from inside the pipeline, for example, data indicating wall thickness, deformation to the pipeline, and/or other corrosion related damages in the pipeline. Further, this data is retrieved and analyzed to identify damages in the pipeline.

In a presently contemplated configuration, the inspection device 104 includes a generating unit 106. It may be noted that the inspection device 104 may include other components, and is not limited to the components shown in FIG. 1. In one example, the other components may be an x-ray generator, a detector, a memory, sensors, and a transceiver that are used to inspect the pipeline.

In the embodiment of FIG. 1, the generating unit 106 includes a stator 108, a magnetic rotor 110, and a support clamp 120. The support clamp 120 is coupled to a shaft 116 which in turn is coupled to the stator 108. The support clamp 120 and the shaft 116 are used to hold the stator 108, while the magnetic rotor 110 rotates about the stator 108. Further, the stator 108 may include electrical coils 112 that are winded over one or more arms 114 of the stator 108. In one example, each of the arms 114 may be positioned perpendicular to the adjacent arm. Further, the electrical coils 112 on each arm 114 are coupled to the electrical coils 112 on the adjacent arm 114. In the embodiment of FIG. 4, the electrical coils 112 are in serial connection with each other. In another embodiment, the electrical coils 112 are in parallel connection with each other. Also, these electrical coils are coupled to an external unit (see FIG. 4) for recharging a battery unit (see FIG. 4). In one example, the battery unit may include one or more on-board batteries of the inspection device 104. It may be noted that the electrical coils 112 may have any type of connection with each other and/or the external unit depending upon the voltage and current requirements of the battery unit.

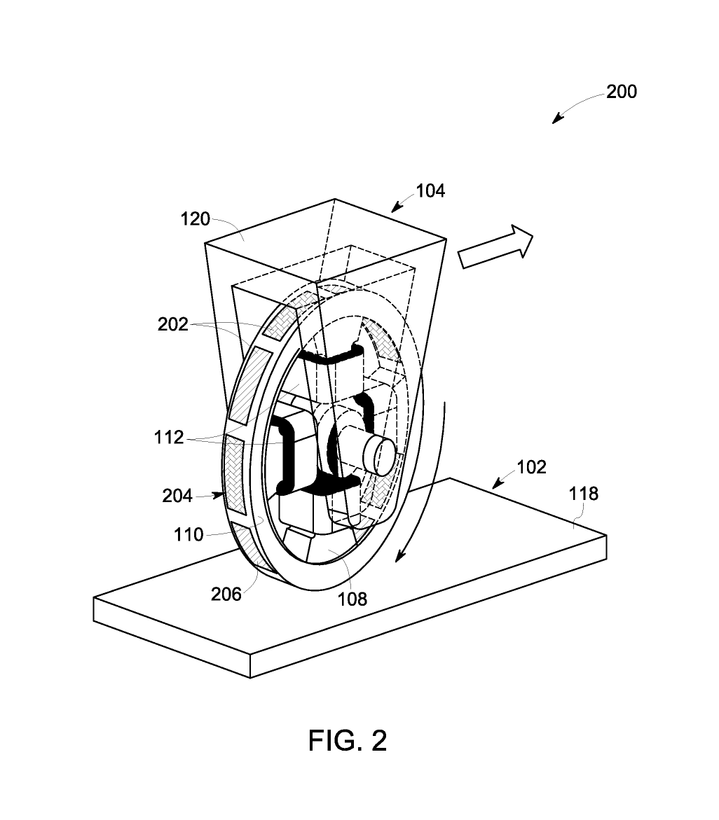

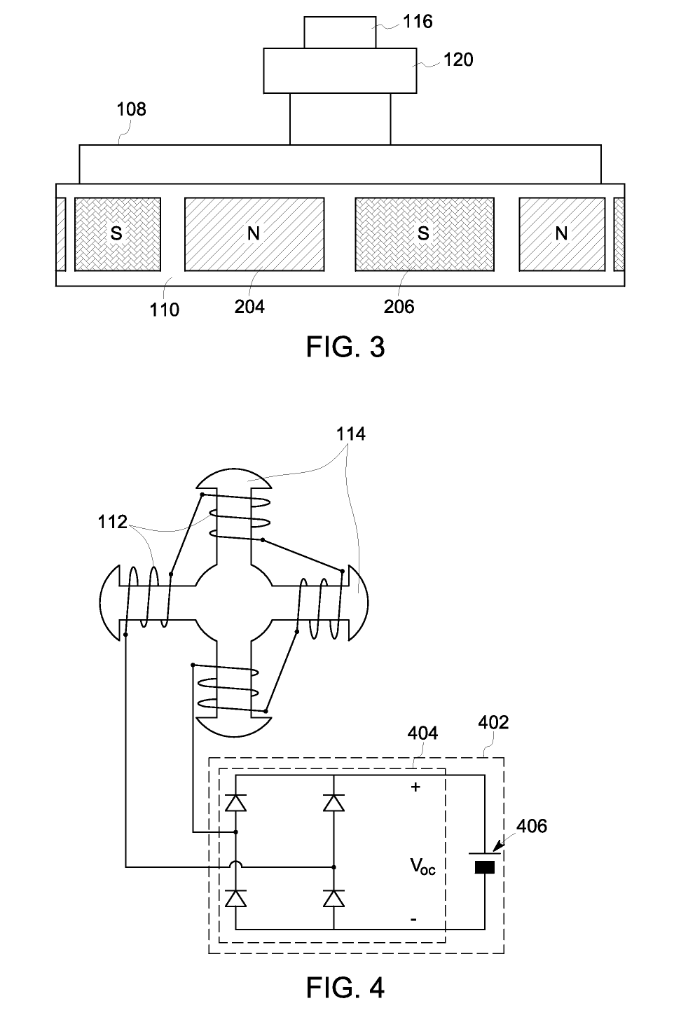

Furthermore, the magnetic rotor 110 is disposed concentric with and radially outside the stator 108. The magnetic rotor 110 is coupled to the stator 108 in such a way that the magnetic rotor 110 may rotate about the stator 108 while the stator 108 is in a fixed or stationary position. Also, the magnetic rotor 110 is positioned proximate to a conductive surface 118 of the conducting tube 102. In addition, the magnetic rotor 110 includes one or more magnets (shown in FIGS. 2 and 3) that are disposed about an outer edge of the magnetic rotor. Also, each of the magnets is disposed adjacent to another magnet having an opposite polarity. In one example, these magnets may be a permanent magnet that is used to create a first magnetic field proximate to the conductive surface 118 of the conducting tube 102.

During operation, the inspection device 104 may move linearly over the conductive surface 118 of the conducting tube 102. This linear movement of the inspection device 104 may be due to liquid flow and/or pressure difference in the conducting tube 102. When the inspection device 104 moves, the generating unit 106 in the inspection device 104 also moves linearly over the conductive surface 118. This linear movement of the generating unit 106 may vary the first magnetic field that is created by the magnetic rotor 110. Particularly, when the generating unit 106 moves linearly over the conductive surface 118, the amplitude and/or direction of the first magnetic field may be varied, and as a result, eddy current is induced in a portion of the conductive surface 118 that is proximate to the magnetic rotor 110. This eddy current may further create a second magnetic field that opposes the first magnetic field. Because of these two opposing or counteracting magnetic fields, a coupled motion or an electromagnetic force acts on the magnetic rotor 110, which in turn causes the magnetic rotor 110 to spin or rotate about the stator 108. It may be noted that the aspect of rotating the magnetic rotor 110 is explained in greater detail with reference to FIGS. 2 and 3.

Further, when the magnetic rotor 110 rotates about the stator 108, an oscillating magnetic field is created in the stator 108, and as a result, voltage is induced in the electrical coils 112 of the stator 108. This voltage may be further transferred to the external unit for charging the on-board batteries of the inspection device 104. It may be noted that the induced voltage may be used for one or more applications in the inspection device 104, and is not limited to charging the on-board batteries of the inspection device 104.

In addition, when current flows from the electrical coils 112 to the external unit to transfer the voltage to the external unit, a third magnetic field that is opposing the second magnetic field is created. This in turn induces a braking force on the magnetic rotor 110 to extract kinetic energy from the magnetic rotor 110 and to transfer power associated with the extracted kinetic energy to the external unit 402.

Thus, by using the exemplary inspection device 104, the on-board batteries may be automatically charged while the inspection device 104 is travelling along the pipeline. Also, the on-board batteries having less size and weight may be employed as they are easily recharged. This in turn reduces the overall size and weight of the inspection device 104.

Referring to FIG. 2, an isometric view of the power generation system, in accordance with one embodiment of the present disclosure, is depicted. Also, FIG. 3 illustrates arrangement of magnetic blocks in the magnetic rotor. The inspection device 104 includes a support clamp 120 that is coupled to a shaft 116 of the inspection device 104, as depicted in FIG. 2. In one example, the supporting clamp may be used to prevent the shaft 116 from rotating, which in turn prevents the stator 108 from rotating, while the magnetic rotor 110 is rotating about the stator 108.

As depicted in FIG. 2, the magnetic rotor 110 includes a plurality of magnetic blocks 202 disposed about an outer edge of the magnetic rotor 110. These magnetic blocks 202 may be used to create a first magnetic field in the conducting tube 102. Also, each magnetic block is disposed adjacent to another magnetic block having an opposite polarity. For example, a magnetic block 204 having a north polarity is disposed adjacent to a magnetic block 206 having a south polarity, as depicted in FIGS. 2 and 3.

Further, when the inspection device 104 moves linearly over the conductive surface 118 of the conducting tube 102, the first magnetic field may induce an eddy current in a portion of the conductive surface 118 that is proximate to the magnetic rotor 110. This eddy current may further create a second magnetic field that opposes the first magnetic field, which in turn creates an electromagnetic force on the magnetic rotor 110. Particularly, when the electromagnetic force acts on the magnetic rotor 110, a magnetic block e.g., 204 that is proximate to the conductive surface 118 and having same polarity as that of the conductive surface 118 may repel from the conductive surface 118, which in turn causes the magnetic rotor 110 to move in a direction as shown in FIG. 2. Further, an adjacent magnetic block e.g., 206 that is proximate the conductive surface 118 and having opposite polarity as that of the conductive surface 118 may attract towards the conductive surface 118, which in turn causes the magnetic rotor 110 to continue moving in the same direction as shown in FIG. 2. This repel and attract action of the magnetic blocks 202 may create a rotational movement of the magnetic rotor 110 about the stator 108, and a result voltage is induced in the electrical coils 112 of the stator 108.

Referring to FIG. 4, a schematic diagram of electrical coils in a stator coupled to an external unit, in accordance with one embodiment of the present disclosure, is depicted. It may be noted that for ease of understanding only the electrical coils 112 and the arms 114 of the stator 108 are depicted in FIG. 4. The electrical coils 112 in each arm 114 are coupled to each other and further coupled to an external unit 402. It may be noted that the electrical coils 112 in each arm 114 may be in serial or parallel connection with each other.

In the embodiment of FIG. 4, the external unit 402 includes a rectifier sub-unit 404 and a battery sub-unit 406. The electrical coils 114 are coupled in parallel to the rectifier sub-unit 404 which is further coupled in parallel to the battery sub-unit 406. In one example, the rectifier sub-unit 404 includes diodes that are arranged in a full bridge circuit to covert AC current from the electrical coils 114 into DC current and to charge the battery sub-unit 106 with the converted DC current. In one example, the battery sub-unit 406 may include one or more on-board batteries that are used to provide system electronics to the inspection device 104. It may be noted that the external unit 402 may include any type of sub-unit to convert the AC current from the electrical coils 114 into DC current, and is not limited to the rectifier sub-unit 404.

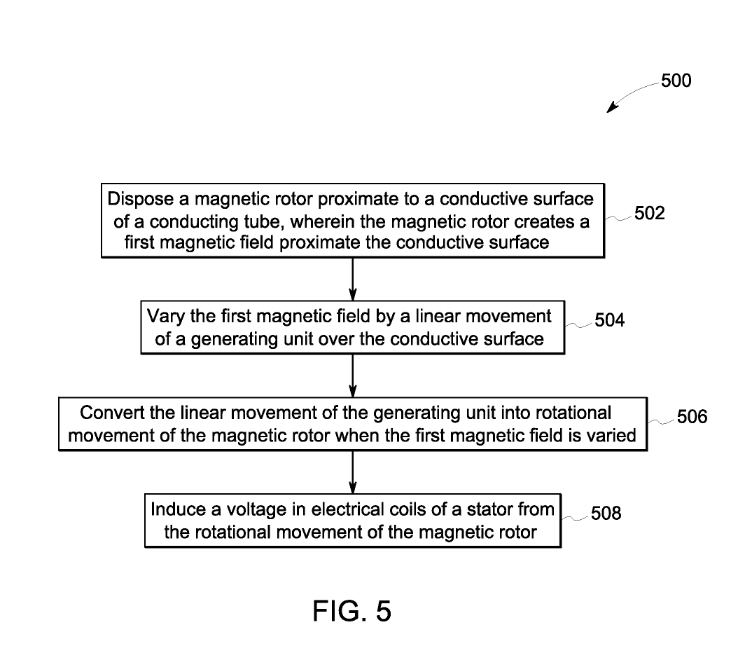

Referring to FIG. 5, a flow chart illustrating a method 500 for generating power in an inspection device 104, in accordance with one embodiment of the present disclosure, is depicted. For ease of understanding, the method 500 is described with reference to the components of FIGS. 1-4. The method 500 begins with step 502, where a magnetic rotor 110 is disposed proximate to a conductive surface 118 of a conducting tube 102. Also, the magnetic rotor 110 may create a first magnetic field proximate to the conductive surface 118.

Subsequently, at step 504, the first magnetic field is varied by a linear movement of a generating unit 106. Particularly, the generating unit 106 in the inspection device 104 may move linearly over the conductive surface 118 due to pressure difference and/or liquid flow in the conducting tube 102. This linear movement of the generating unit 106 may further vary the amplitude and/or direction of the first magnetic field created by the magnetic rotor 110.

In addition, at step 506, the linear movement of the generating unit 106 may be converted into rotational movement of the magnetic rotor 110 when the first magnetic field is varied. More specifically, when the amplitude and/or direction of the first magnetic field are varied by the linear movement of the generating unit 106, an eddy current is induced in the conductive surface 118. This eddy current in the conductive surface 118 may further create a second magnetic field that opposes the first magnetic field. Because of these two opposing magnetic fields, a coupled motion or an electromagnetic force may act on the magnetic rotor 110, which in turn causes the magnetic rotor 110 to spin or rotate about the stator 108.

Furthermore, at step 508, the rotational movement of the magnetic rotor 110 may induce a voltage in the electrical coils 112 of the stator 108. Particularly, when the magnetic rotor 110 rotates about the stator 108, an oscillating magnetic field is created in the stator 108 and as a result, voltage is induced in the electrical coils 112 of the stator 108. This voltage may be further transferred to the external unit 402 for charging the on-board batteries 406 of the inspection device 104. In addition, when electrical current flows from the electrical coils 112 to the external unit 402 to transfer power to the external unit 402, a third magnetic field that is opposing the second magnetic field is created. This in turn induces a braking force on the magnetic rotor 110 to extract kinetic energy from the magnetic rotor 110 and to transfer power associated with the extracted kinetic energy to the external unit 402. Further, when the generating unit 106 moves again over the conductive surface 118, the cycle (steps 502-508) repeats to induce voltage and re-charge the on-board batteries.

The various embodiments of the system and the method may be used for charging the on-board batteries of the inspection device. Also, the on-board batteries are charged while the inspection device is travelling along the pipeline. Thus, there is no need to remove the on-board batteries for charging or replacing with new on-board batteries. Also, less number of on-board batteries may be used as they can be easily charged while travelling along the pipeline. This in turn reduces the size and weight of the inspection device.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power generation system comprising:
a conducting tube;
a generating unit configured to move linearly over a conductive surface of the conducting tube and comprising:
a magnetic rotor configured to create a first magnetic field proximate the conductive surface; and
a stator disposed concentric with and radially inside the magnetic rotor, and comprising electrical coils,
wherein the magnetic rotor rotates about the stator to induce a voltage in the electrical coils when the generating unit moves linearly over the conductive surface of the conducting tube.

2. The power generation system of claim 1, wherein the first magnetic field induces an eddy current in the conductive surface when the generating unit moves linearly over the conductive surface.

3. The power generation system of claim 2, wherein the eddy current in the conductive surface creates a second magnetic field opposing the first magnetic field.

4. The power generation system of claim 3, wherein when the second magnetic field opposes the first magnetic field, electromagnetic force acts on the magnetic rotor.

5. The power generation system of claim 4, wherein the magnetic rotor rotates to induce the voltage in the electrical coils when the electromagnetic force acts on the magnetic rotor.

6. The power generation system of claim 1, wherein the electrical coils are electrically coupled to an external unit and configured to transfer the voltage to the external unit.

7. The power generation system of claim 6, wherein electrical current flows from the electrical coils to the external unit to transfer power to the external unit.

8. The power generation system of claim 7, wherein the electrical current in the electrical coils create a third magnetic field opposing the second magnetic field.

9. The power generation system of claim 8, wherein when the third magnetic field opposes the second magnetic field, a braking force is induced on the magnetic rotor to extract power from the magnetic rotor and to transfer the extracted power to the battery.

10. A method for generating electrical power, the method comprising:
disposing a magnetic rotor proximate to a conductive surface of a conducting tube, wherein the magnetic rotor creates a first magnetic field proximate the conductive surface;
varying the first magnetic field by a linear movement of a generating unit over the conductive surface;
converting the linear movement of the generating unit into rotational movement of the magnetic rotor when the first magnetic field is varied; and
inducing a voltage in electrical coils of a stator from the rotational movement of the magnetic rotor.

11. The method of claim 10, wherein converting the linear movement of the generating unit into the rotational movement of the magnetic rotor comprises:
inducing an eddy current in the conductive surface when the first magnetic field is varied by the linear movement of the generating unit; and
creating an electromagnetic force to rotate the magnetic rotor when the eddy current is induced in the conductive surface.

12. The method of claim 11, wherein creating the electromagnetic force to rotate the magnetic rotor comprises:
creating a second magnetic field from the eddy current in the conductive surface; and
inducing an electromagnetic force on the magnetic rotor when the second magnetic field opposes the first magnetic field.

13. The method of claim 10, further comprising supplying electrical current from the electrical coils to an external unit for transferring the induced voltage to the external unit.

14. The method of claim 13, wherein supplying the electrical current comprises:
creating a third magnetic field when the electrical current is supplied from the electrical coils to the external unit; and
inducing a braking force on the magnetic rotor when the third magnetic field opposes the second magnetic field.

15. The method of claim 13, wherein supplying the electrical current comprises charging a battery in the external unit from the electrical current in the electrical coils.

16. A power generating device comprising:
a generating unit configured to move linearly over a conductive surface, wherein the generating unit comprises:
a stator comprising electrical coils;
a magnetic rotor disposed concentric with and radially outside the stator, wherein the magnetic rotor is configured to:
create a first magnetic field proximate the conductive surface; and
rotate about the stator to induce a voltage in the electrical coils when the generating unit moves linearly over the conductive surface.

17. The power generating device of claim 16, wherein the first magnetic field induces an eddy current in the conductive surface when the generating unit moves linearly over the conductive surface.

18. The power generating device of claim 17, wherein the eddy current in the conductive surface creates a second magnetic field opposing the first magnetic field.

19. The power generating device of claim 18, wherein when the second magnetic field opposes the first magnetic field, electromagnetic force acts on the magnetic rotor.

20. The power generating device of claim 19, the magnetic rotor rotates to induce the voltage in the electrical coils when the electromagnetic force acts on the magnetic rotor.

21. The power generating device of claim 16, where the magnetic rotor comprises a plurality of magnets disposed about an outer edge of the magnetic rotor, wherein each magnet of the plurality of magnets is disposed adjacent to another magnet of the plurality of magnets having an opposite polarity.
